(19) United States
(12) Patent Application Publication
(10) Pub. No.: US 2007/0052310 A1
(43) Pub. Date: Mar. 8, 2007

(54) Fluid pump and electric motor, and manufacturing method for the same

(75) Inventors: Hiromi Sakai, Nukata-gun (JP); Kiyoshi Nagata, Nagoya-city (JP); Shinji Sumiya, Hekinan-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/515,790

(22) Filed: Sep. 6, 2006

(30) Foreign Application Priority Data
Sep. 6, 2005 (JP) 2005-257416
Oct. 18, 2005 (JP) 2005-302698
Oct. 31, 2005 (JP) 2005-315974
Dec. 1, 2005 (JP) 2005-347593
Jun. 21, 2006 (JP) 2006-171173

(51) Int. Cl. H02K 1/04; H02K 5/12; F04B 17/00

(52) U.S. Cl. 310/87; 310/43; 417/423.3; 417/365

(57) ABSTRACT

A fluid pump includes a motor portion that has a stationary part and a rotator. The inner circumferential periphery of the stationary part and the outer circumferential periphery of the rotator define a fuel passage therebetween. The rotator is rotatable around the inner circumferential periphery of the stationary part. The motor portion drives a pump portion for pumping fuel through the fuel passage. The rotator includes a permanent magnet that is formed by injection molding a composite material containing a magnetic material and resin. The permanent magnet has one end with respect to the axial direction of the permanent magnet. The one end defines an axial end surface. The axial end surface has an injection port mark.

### CROSS REFERENCE TO RELATED APPLICATIONS

This application is based on and incorporates herein by reference Japanese Patent Applications No. 2005-257416 filed on Sep. 6, 2005, No. 2005-302698 filed on Oct. 18, 2005, No. 2005-315974 filed on Oct. 31, 2005, No. 2005-347593 filed on Dec. 1, 2005, and No. 2006-171173 filed on Jun. 21, 2006.

### FIELD OF THE INVENTION

The present invention relates to a fluid pump and an electric motor, and a manufacturing method for the fluid pump and the electric motor. The present invention also relates to a manufacturing method for a permanent magnet of the electric motor.

### BACKGROUND OF THE INVENTION

According to JP-A-2001-268874, an electric motor includes a rotator and a stationary part for generating magnetic field. One of the rotator and the stationary part may be formed of a permanent magnet, which is formed by injection molding a composite material containing a magnetic material and resin into a molding die through an injection port. When an injection port mark is formed on a surface of the permanent magnet defining a wall surface of a fuel passage, fluid resistance in the fuel passage may increase due to a protrusion and a recession defined by the injection port mark. Furthermore, the portion defining the injection port mark on the permanent magnet is apt to be rust due to being submerged in fuel. When the portion defining the injection port mark is elevated in the permanent magnet due to rust development, fluid resistance in the fuel passage may further increase.

In addition, in the above electric motor, a shaft is inserted into a cylindrical through hole of the permanent magnet, so that the permanent magnet is fixed. However, when the through hole of the permanent magnet is deformed due to aging or the like, bond strength between the permanent magnet and the shaft may decrease, and the shaft may be peeled off the permanent magnet. A resin member supporting a permanent magnet or a coil may be fixed to the shaft similarly to the above permanent magnet. Even in this structure, the permanent magnet or the coil may be removed from the shaft when the resin member is peeled off the shaft. In this case, torque generated in the permanent magnet or the coil may not be properly transmitted to the shaft due to movement of the permanent magnet or the coil with respect to the shaft.

### SUMMARY OF THE INVENTION

In view of the foregoing and other problems, it is an object of the present invention to produce a fuel pump including a rotator and a stationary part defining a fuel passage, in which fluid resistance can be restricted. It is another object of the present invention to produce an electric motor, in which a permanent magnet or a coil is maintained on a shaft of a rotator.

According to one aspect of the present invention, a fluid pump includes a motor portion that has a stationary part and a rotator. The stationary part has an inner circumferential periphery. The rotator has an outer circumferential periphery. The inner circumferential periphery and the outer circumferential periphery define a fuel passage therebetween. The rotator is rotatable around the inner circumferential periphery. The fluid pump further includes a pump portion that is driven by the motor portion for pumping fuel through the fuel passage. The rotator includes a permanent magnet that is formed by injection molding a composite material containing a magnetic material and resin. The permanent magnet has one end with respect to an axial direction of the permanent magnet. The one end defines an axial end surface. The axial end surface has an injection port mark.

Alternatively, according to another aspect of the present invention, a fluid pump includes a motor portion that has a stationary part and a rotator. The stationary part has an inner circumferential periphery. The rotator has an outer circumferential periphery. The inner circumferential periphery and the outer circumferential periphery define a fuel passage therebetween. The rotator is rotatable around the inner circumferential periphery. The fluid pump further includes a pump portion that is driven by the motor portion for pumping fuel through the fuel passage. The stationary part includes a permanent magnet that is formed by injection molding a composite material containing a magnetic material and resin. The permanent magnet has one end with respect to an axial direction of the permanent magnet. The one end defines an axial end surface. The axial end surface has an injection port mark.

Alternatively, according to another aspect of the present invention, a fluid pump includes a motor portion that has a stationary part and a rotator. An inner circumferential periphery of the stationary part and an outer circumferential periphery of the rotator define a fuel passage therebetween. The rotator is rotatable around the inner circumferential periphery of the stationary part. One of the stationary part and the rotator includes a permanent magnet having an axial end surface on a side of one end of the permanent magnet with respect to an axial direction of the permanent magnet. The fluid pump further includes a pump portion that pumps fuel through the fuel passage by being driven by the motor portion. A manufacturing method for the fluid pump includes forming the permanent magnet by injection molding a composite material containing a magnetic material and resin using a die having an injection port in a portion for forming the axial end surface of the permanent magnet.

Alternatively, according to another aspect of the present invention, a manufacturing method for a permanent magnet, which constructs one of a stationary part and a rotator of an electric motor, includes injecting a composite material containing a magnetic material and resin into a die through an injection port. The manufacturing method for the permanent magnet further includes forming a permanent magnet, which is in a substantially cylindrical shape, in the die by solidifying the composite material in the die and the injection port. The manufacturing method for the permanent magnet further includes removing the composite material, which is solidified in the injection port, from an axial end surface of the permanent magnet. The axial end surface defines one end of the permanent magnet with respect to an axial direction of the permanent magnet.

Alternatively, according to another aspect of the present invention, a manufacturing method for an electric motor, which has a permanent magnet constructing one of a stationary part and a rotator, includes injecting a composite material containing a magnetic material and resin into a die through an injection port. The manufacturing method for the electric motor further includes forming a permanent magnet, which is in a substantially cylindrical shape, in the die by solidifying the composite material in the die and the injection port. The manufacturing method for the electric motor further includes removing the composite material, which is solidified in the injection port, from an axial end surface of the permanent magnet. The axial end surface defines one end of the permanent magnet with respect to an axial direction of the permanent magnet. The manufacturing method for the electric motor further includes combining the permanent magnet as the one of the stationary part and the rotator substantially coaxially with an other of the stationary part and the rotator such that the permanent magnet and the other of the stationary part and the rotator define a substantially cylindrical fluid passage radially therebetween.

Alternatively, according to another aspect of the present invention, an electric motor includes a stationary part that has an inner circumferential periphery. The electric motor further includes a rotator that is rotatable around the inner circumferential periphery. The rotator includes a shaft and a resin portion. The shaft has an outer circumferential periphery that defines a recess. The resin portion is formed by injection molding one of resin and a composite material. The composite material contains resin. The resin portion covers the recess.

Alternatively, according to another aspect of the present invention, an electric motor includes a stationary part that has an inner circumferential periphery. The electric motor further includes a rotator that is rotatable around the inner circumferential periphery. The rotator includes a shaft and a resin portion. The shaft has an outer circumferential periphery that defines a protrusion. The resin portion is formed by injection molding one of resin and a composite material. The composite material contains resin. The resin portion covers the protrusion.

### BRIEF DESCRIPTION OF THE DRAWINGS

The above and other objects, features and advantages of the present invention will become more apparent from the following detailed description made with reference to the accompanying drawings. In the drawings:

FIG. 1 is a longitudinal partially sectional view showing a fuel pump according to a first embodiment;

FIG. 2 is a sectional view showing a die for molding a permanent magnet of the fuel pump;

FIGS. 3A to 3C are schematic views showing modified examples of the permanent magnet;

FIG. 4 is a partially sectional view showing a permanent magnet and a shaft of a fuel pump, according to a second embodiment;

FIG. 5 is a longitudinal partially sectional view showing a fuel pump according to a third embodiment;

FIG. 6 is a longitudinal partially sectional view showing a fuel pump according to a fourth embodiment;

FIG. 7 is a schematic view showing a permanent magnet and a shaft of the fuel pump according to the fourth embodiment;

FIG. 8 is a partially sectional view showing a modified example of the permanent magnet and the shaft according to the fourth embodiment;

FIG. 9 is a partially sectional view showing a modified example of the permanent magnet and the shaft according to the fourth embodiment;

FIG. 10 is a partially sectional view showing a modified example of the shaft according to the fourth embodiment;

FIGS. 11A to 11C are schematic views showing modified examples of the permanent magnets and the shafts according to the fourth embodiment;

FIG. 12 is a partially sectional view showing a permanent magnet and a shaft according to a fifth embodiment; and

FIG. 13 is a partially sectional view showing a permanent magnet and a shaft according to a sixth embodiment.

### DETAILED DESCRIPTION OF PREFERRED EMBODIMENTS

### First Embodiment

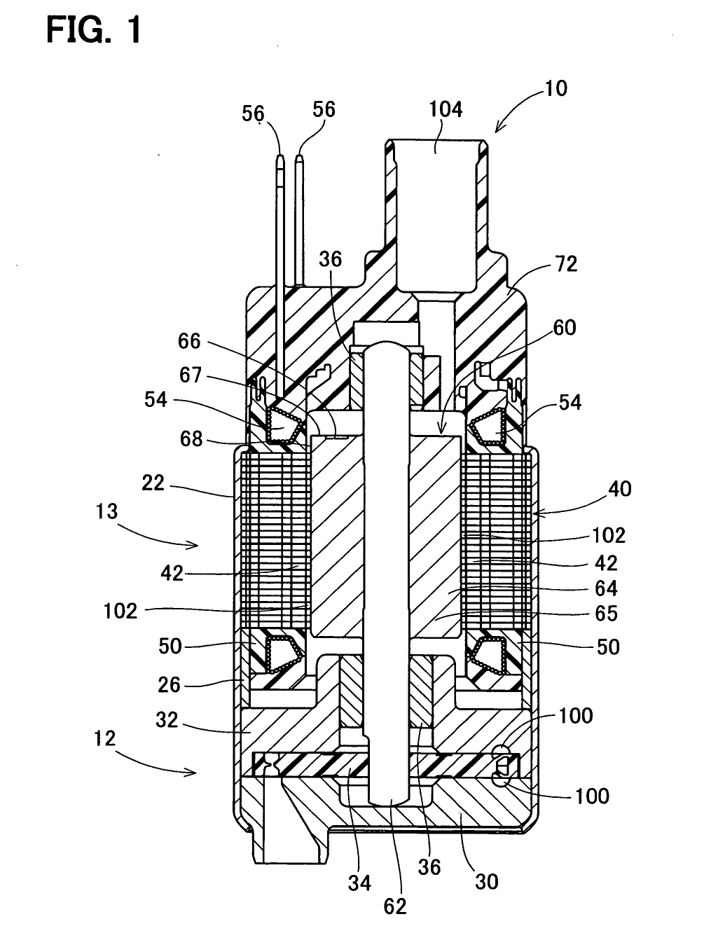

As shown in FIG. 1, a fuel pump 10 of this embodiment is an in-tank turbine pump, for example. The fuel pump 10 is provided in a fuel tank of a motorcycle with an engine size of 150 cc, for example. The fuel pump 10 includes a pump portion 12 and a motor portion 13. The motor portion 13 rotates the pump portion 12.

The housing 22 accommodates the pump portion 12 and the motor portion 13. The pump portion 12 includes pump cases 30, 32 that rotatably accommodate an impeller 34. The pump cases 30, 32 and the impeller 34 define pump passages 100 thereamong. The pump passages 100 are in substantially C-shapes.

The motor portion 13 serves as a brushless motor that includes a stator core 40, bobbins 50, coils 54, and a rotator 60. The stator core 40 serves as a stationary part. The stator core 40 is formed by crimping axially stacked magnetic steel plates to each other. The stator core 40 is provided with six teeth 42 protruding toward the center of the motor portion 13. The six teeth 42 are circumferentially arranged at substantially regular intervals. Each of the coils 54 is wound around each of the bobbins 50 of each of the teeth 42. Each of the coils 54 electrically connects with each of terminals 56. Supplying electricity to each of the coils 54 is controlled in accordance with a rotational position of the rotator 60.

The rotator 60 includes a shaft 62 and a permanent magnet 64. The rotator 60 is rotatable around the inner circumferential periphery of the stator core 40. The permanent magnet 64 is a resin magnet that is produced by mixing magnetic powder such as NeFeB with thermoplastic resin such as polyphenylene sulfide (PPS). The shaft 62 is insert-molded of the permanent magnet 64. The permanent magnet 64 has eight magnetic poles 65 arranged with respect to the rotative direction. The eight magnetic poles 65 are magnetized to define magnetic poles toward the outer circumferential periphery of the permanent magnet 64. The outer circumferential periphery of the permanent magnet 64 is opposed to the inner circumferential periphery of the stator core 40. The magnetic poles are different from each other with respect to the rotative direction of the rotator 60. The shaft 62 is rotatably supported by bearings 36 at both ends.

An end cover 72 is integrally molded of resin when the stator core 40 and the coils 54 are molded of the resin. The end cover 72 has an outlet port 104.

Fuel is drawn through an inlet port provided to the pump case 30. Fuel is drawn through the inlet port, and is pressurized through the pump passages 100 by rotation of the impeller 34. The pressurized fuel is press-fed toward the outlet port 104 through a fuel passage 102 defined between the inner circumferential periphery of the stator core 40 and the outer circumferential periphery of the rotator 60. The fuel is discharged toward the engine through the outlet port 104.

When the wall surface of the fuel passage 102 has a protrusion and recession, fluid resistance increases in the fuel passage 102. Consequently, a discharge rate of fuel relative to energy consumption of the motor portion 13 may decrease.

Therefore, in the first embodiment, an outer circumferential end 68 of the permanent magnet 64 is formed to be substantially flat in order to enhance the discharge rate of fuel relative to energy consumption of the motor portion 13. The outer circumferential end 68 of the permanent magnet 64 partially defines the fuel passage 102.

The permanent magnet 64 is injection-molded by the following method.

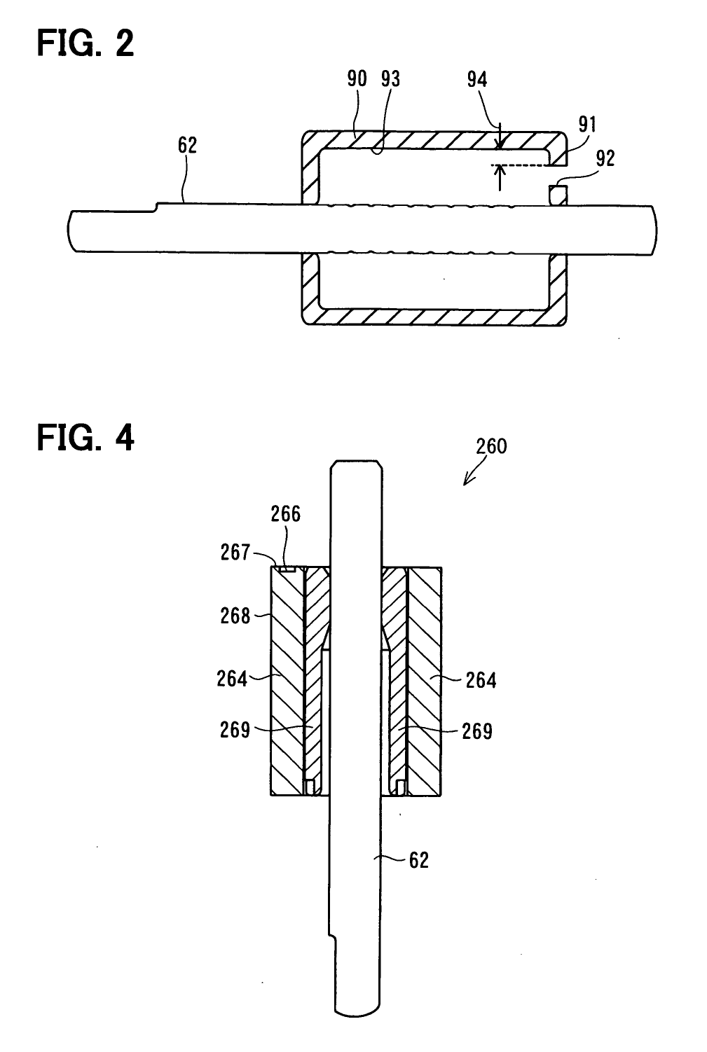

As shown in FIG. 2, first, the shaft 62 is fixed to a die 90 such that the shaft 62 is partially exposed into the die 90. The die 90 has an injection port 92 around an axial end 91, which is located on the end of the die 90 with respect to the axial direction of the shaft 62. Subsequently, the permanent magnet 64 is injection-molded by injecting a composite material through the injection port 92 into the die 90. The composite material contains the thermoplastic resin and the magnetic powder.

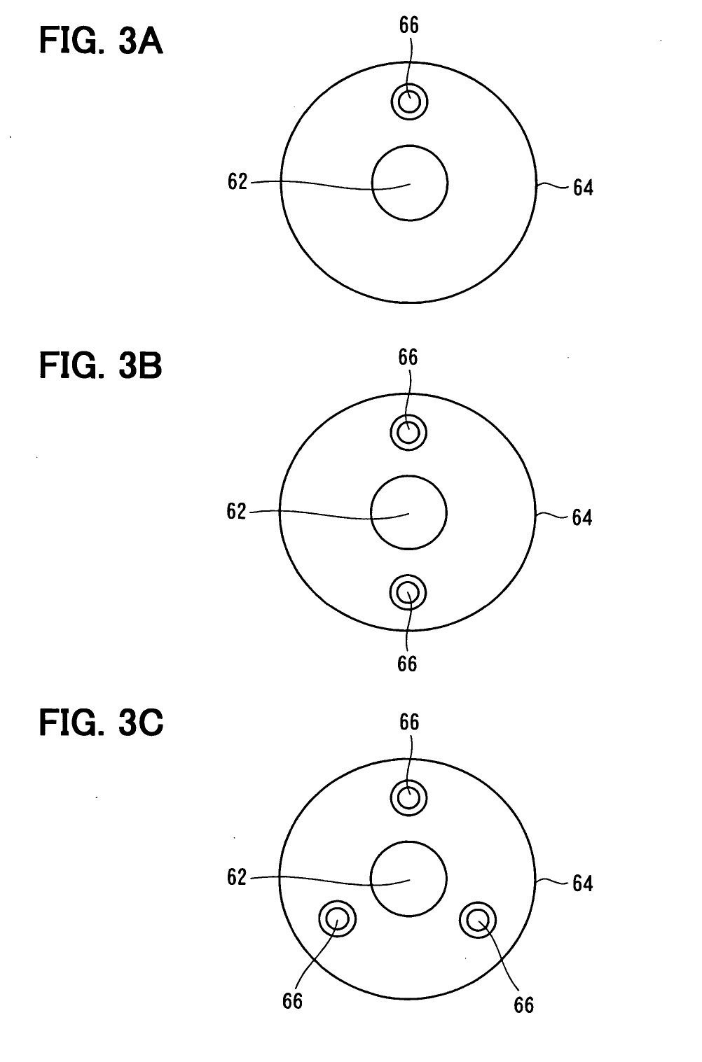

The permanent magnet 64 formed by the above method has an injection port mark 66 on an axial end surface 67 of the permanent magnet 64. The axial end surface 67 is located on the end of the permanent magnet 64 with respect to the axial direction of the shaft 62. That is, the permanent magnet 64 does not have the injection port mark 66 in the outer circumferential end 68 defining the fuel passage 102. Therefore, fluid resistance in the fuel passage 102 is restricted from increasing due to a protrusion, a recession, and the like in the injection port mark 66. Thus, fluid resistance in the fuel passage 102 can be reduced. When at least one of the injection port mark 66 is formed on the axial end surface 67 of the permanent magnet 64, as shown in FIG. 3A, one injection port mark 66 may be formed on the axial end surface 67. Alternatively, as shown in FIGS. 3B to 3C, two or more of the injection port marks 66 may be formed on the axial end surface 67.

The axial end surface 67 and the outer circumferential end 68 define a substantially annular corner in the permanent magnet 64. The substantially annular corner of the permanent magnet 64 is chamfered, in general. In a structure, in which the corner of the permanent magnet 64 is chamfered, a substantially annular chamfered region may be defined in the axial end surface 67 around the outer circumferential end 68. The chamfered region may have a width with respect to the radial direction of the permanent magnet 64. The width of the chamfered region may be about 0.3 mm inwardly from the outer circumferential end 68. The chamfered region in the axial end surface 67 may be slanted toward the fuel passage 102 by chamfering the permanent magnet 64.

When rust develops in the permanent magnet 64, the injection port mark 66 may be partially elevated, or the axial end surface 67 around the injection port mark 66 may be elevated. If the injection port mark 66 is formed in the chamfered region inclined toward the fuel passage 102, the injection port mark 66 or the axial end surface 67 around the injection port mark 66 may be elevated due to rust development in the permanent magnet 64. Consequently, the elevated portion may protrude into the fuel passage 102.

As referred to FIG. 2, the permanent magnet 64 is injection-molded using the die 90 having the axial end 91 defining the injection port 92. As depicted by the arrow 94 in FIG. 2, the injection port 92 may be spaced from an inner wall surface 93 of the die 90 for a predetermined distance or more with respect to the radial direction of the shaft 62. The inner wall surface 93 of the die 90 defines the outer circumferential end 68 of the permanent magnet 64. The predetermined distance may be about 0.3 mm in consideration of the chamfering generally applied to the corner defined between the axial end surface 67 and the outer circumferential end 68 in the permanent magnet 64.

The permanent magnet 64 formed in the above manner has the injection port mark 66 in a region excluding the chamfered region in the axial end surface 67. That is, the injection port mark 66 is formed in a region excluding the chamfered region that is not slanted toward the fuel passage 102. Consequently, even the axial end surface 67 around the injection port mark 66 is partially elevated due to rust development, the elevated portion can be restricted from protruding toward the fuel passage 102, so that fluid resistance in the fuel passage 102 can be restricted from increasing due to the elevated portion.

In this embodiment, each permanent magnet is formed of the composite material containing a magnetic material and resin such as polyphenylene sulfide (PPS). PPS has high chemical resistance, so that the permanent magnet can be protected from deterioration caused by being submerged in fuel.

In this embodiment, each fuel pump can be produced through a simple process, which does not need a manufacturing step such as removing an injection port mark formed in either the inner circumferential end or the outer circumferential end of the permanent magnet defining the fuel passage. Thus, fluid resistance in the fuel passage defined between the rotator and the stationary part can be restricted by manufacturing the fuel pump without removing the injection port mark, for example.

### Second Embodiment

As shown in FIG. 4, a rotator 260 of a fuel pump of the second embodiment includes the shaft 62, a rotational core 269, and a permanent magnet 264. The permanent magnet 264 is a resin magnet that is formed by injection molding a composite material containing thermoplastic resin such as PPS and magnetic powder such as NeFeB. The permanent magnet 264 is shaped to be in a substantially cylindrical shape, and is fixed to the outer circumferential periphery of the rotational core 269. The permanent magnet 264 has eight magnetic poles arranged with respect to the rotative direction, similarly to the permanent magnet 64 in the first embodiment.

The pressurized fuel is press-fed toward an outlet port through a fuel passage defined between the inner circumferential periphery of a stator core and an outer circumferential end 268 of the permanent magnet 264, and the fuel is discharged toward the engine through the outlet port, similarly to the fuel pump 10 in the first embodiment.

An injection port mark 266 is defined in an end surface 267 of the permanent magnet 264 with respect to the axial direction of the shaft 62. That is, an injection port mark is not formed in the wall surface of the fuel passage defined between the inner circumferential periphery of the stator core and the outer circumferential end 268 of the permanent magnet 264. Thus, fluid resistance in the fuel passage can be restricted from increasing. The injection port mark 266 is formed in the end surface 267 of the permanent magnet 264. The injection port mark 266 is spaced from the outer circumferential end 268, which defines the fuel passage, for about 0.3 mm or more with respect to the radial direction of the shaft 62, similarly to the permanent magnet 64 in the first embodiment. Thus, fluid resistance in the fuel passage can be restricted from increasing due to elevation around the injection port mark 266.

### Third Embodiment

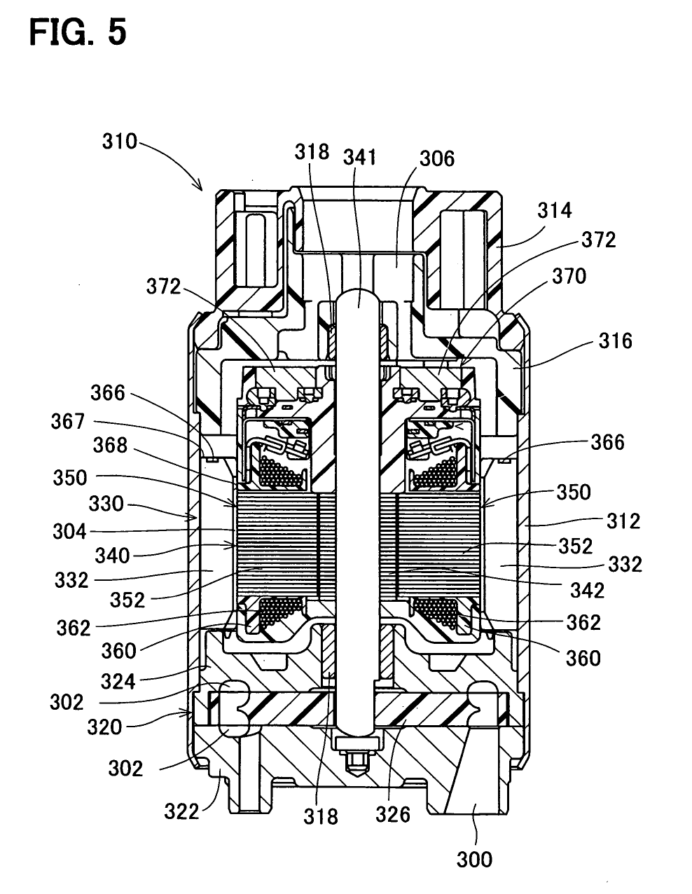

As shown in FIG. 5, a fuel pump 310 includes a pump portion 320, a motor portion 330, and an end support cover 314. The motor portion 330 rotates an impeller 326 of the pump portion 320. The housing 312 surrounds the outer circumferential peripheries of the pump portion 320 and the motor portion 330. The housing 312 is a common housing of the pump portion 320 and the motor portion 330. The end support cover 314 covers the motor portion 330 on the opposite side of the pump portion 320. The end support cover 314 defines an outlet port 306 of fuel.

The pump portion 320 is a Wesco pump, for example. The pump portion 320 includes a pump cover 322, a pump casing 324, and the impeller 326. The pump cover 322 and the pump casing 324 are casing member that rotatably accommodates the impeller 326. The pump cover 322 and the impeller 326 define a pump passage 302 therebetween. The pump casing 324 and the impeller 326 define the pump passage 302 therebetween. The pump passages 302 are in substantially C-shapes.

Each of permanent magnets 332 is a resin magnet that is formed by injection molding a composite material containing thermoplastic resin such as PPS and magnetic powder. Each of the permanent magnets 332 is shaped to be in a substantially quarter arc shape. Four permanent magnets 332 are provided to the inner circumferential wall of the housing 312 circumferentially at regular intervals, thereby defining magnetic poles different from each other with respect to the rotative direction in the motor portion 330.

A commutator 370 is assembled to the end of an armature 340 on the opposite side of the pump portion 320 with respect to the axial direction of a shaft 341. The permanent magnets 332, the armature 340, the commutator 370, and an unillustrated brush construct a direct-current motor. The armature 340 includes the shaft 341 that is rotatably supported by bearings 318 that are respectively accommodated in and fixed to the pump casing 324 and the bearing holder 316.

The armature 340 includes a center core 342 in the rotation center thereof. The shaft 341 is press-inserted into the center core 342. The center core 342 is in a cylindrical shape being substantially hexagonal in cross section. Six slots 350 are provided to the outer circumferential periphery of the center core 342 and arranged with respect to the rotative direction. Each of the slots 350 includes a coil core 352, a bobbin 360, and a coil 362. The coil 362 is a concentrated winding, which is formed by winding a wire around the bobbin 360.

The commutator 370 includes twelve segments 372 that are arranged with respect to the rotative direction of the commutator 370.

An inlet port 300 is provided to the pump cover 322. Fuel is drawn through the inlet port 300, and is pressurized through the pump passages 302 by rotation of the impeller 326. The pressurized fuel is press-fed into a fuel passage 304 defined between the permanent magnets 332 and the armature 340 in the motor portion 330. Thus, fuel is discharged from the outlet port 306 after passing through the fuel passage 304.

Each of the permanent magnets 332 has an axial end surface 367 with respect to the axial direction of the shaft 341. The axial end surface 367 of each of the permanent magnets 332 defines an injection port mark 366. In this structure, the wall surface of the fuel passage 304 can be restricted from causing a protrusion and a recession due to defining an injection port mark therein. Thus, fluid resistance in the fuel passage 304 can be reduced.

In the above structure, the injection port mark 366 is formed in the axial end surface 367 of the permanent magnet 332. The injection port mark 366 is spaced from an inner circumferential periphery 368, which defines the fuel passage 304, for 0.3 mm or more with respect to the radial direction of the shaft 341 similarly to the permanent magnet 64 in the first embodiment. Thus, fluid resistance in the fuel passage 304 can be restricted from increasing due elevation around the injection port mark 366.

In this embodiment, the permanent magnets 332 may serve as a stationary part. The armature 340 and the commutator 370 may serve as a rotator.

In the above embodiments, the above manufacturing method for the electric motor, which has the permanent magnet constructing one of the stationary part and the rotator, includes injecting the composite material containing the magnetic material and resin into the die through the injection port. The permanent magnet, which is in a substantially cylindrical shape, may be formed in the die by solidifying the composite material in the die and the injection port. The manufacturing method for the electric motor may further include removing the composite material, which is solidified in the injection port, from the axial end surface of the permanent magnet. The manufacturing method for the electric motor may further include combining the permanent magnet as the one of the stationary part and the rotator substantially coaxially with the other of the stationary part and the rotator such that the permanent magnet and the other of the stationary part and the rotator define a substantially cylindrical fluid passage radially therebetween.

### Fourth Embodiment

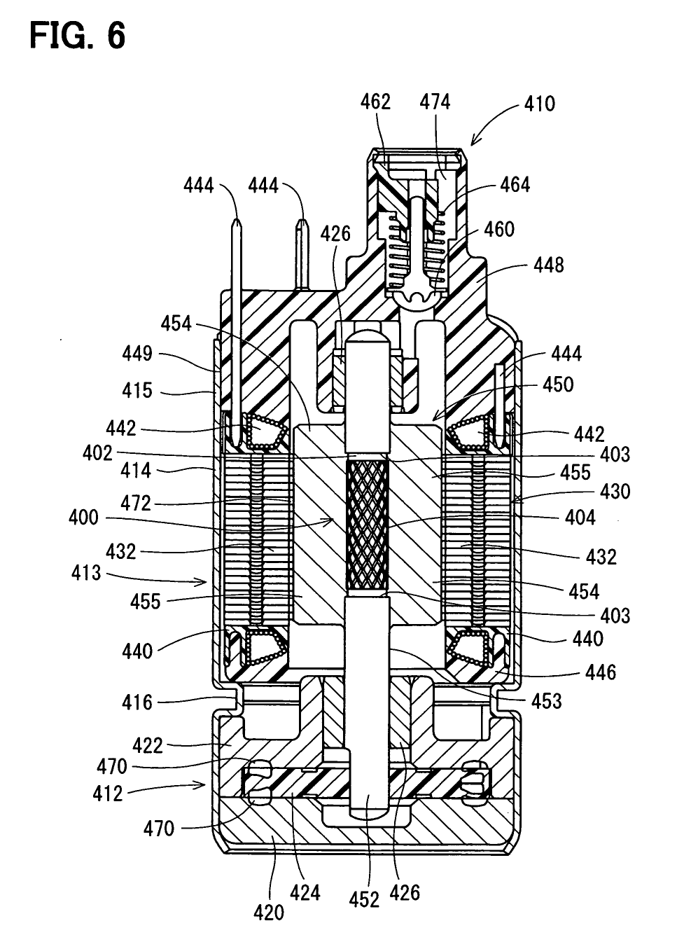

As shown in FIG. 6, a fuel pump 410 of this embodiment is an in-tank turbine pump that is provided in a fuel tank. The fuel pump 410 may be applied to a motorcycle with an engine size of 150 cc, for example.

The fuel pump 410 includes a pump portion 412 and a motor portion 413. The motor portion 413 rotates the pump portion 412. A housing 414 is shaped by press-forming a metallic thin plate to be in a substantially cylindrical shape. This thickness of the metallic thin plate may be about 0.5 mm. The housing 414 serves as a housing of the pump portion 412 and the motor portion 413. The housing 414 formed of the thin plate has a protrusion 416. The protrusion 416 is formed by radially inwardly denting the housing 414 between a pump portion 412 and a motor portion 413.

The pump portion 412 is a turbine pump that includes pump cases 420, 422, and an impeller 424. The pump case 422 is press-inserted into the housing 414 axially onto the protrusion 416 of the housing 414. Thus, the pump case 422 is axially aligned. The pump case 420 is fixed by crimping one end of the housing 414.

The pump cases 420, 422 rotatably accommodate the impeller 424. The pump cases 420, 422 and the impeller 424 define fuel passages 470 in substantially C-shapes thereamong. Fuel is drawn through an unillustrated inlet port provided to the pump case 420, and is pressurized through the fuel passages 470 by rotation of the impeller 424, thereby being press-fed toward the motor portion 413. The fuel press-fed toward the motor portion 413 is supplied toward an engine through an outlet port 474 after passing through a fuel passage 472 defined between the stator core 430 and the rotator 450. The outlet port 474 is defined on the axially opposite side of the pump portion 412 with respect to the motor portion 413.

The motor portion 413 serving as an electric motor is a brushless motor that includes the stator core 430, bobbins 440, coils 442, and the rotator 450. The stator core 430 serving as a stationary part is constructed of six cores 432 that are circumferentially arranged. An unillustrated control apparatus performs full wave control of three phase current supplied to each of the coils 442 in accordance with a rotational position of the rotator 450, thereby switching magnetic poles defined in the inner circumferential peripheries of the cores 432 opposed to the rotator 450.

Each of the bobbins 440 formed of electrically insulative resin engages with each of the cores 432. Each of the coils 442 is formed by concentrically winding a wire around each of the bobbins 440 in a condition where each of the core 432 is a single component before being assembled to the fuel pump 410. Each of the coils 442 electrically connects with each of terminals 444 on the side of an end cover 448.

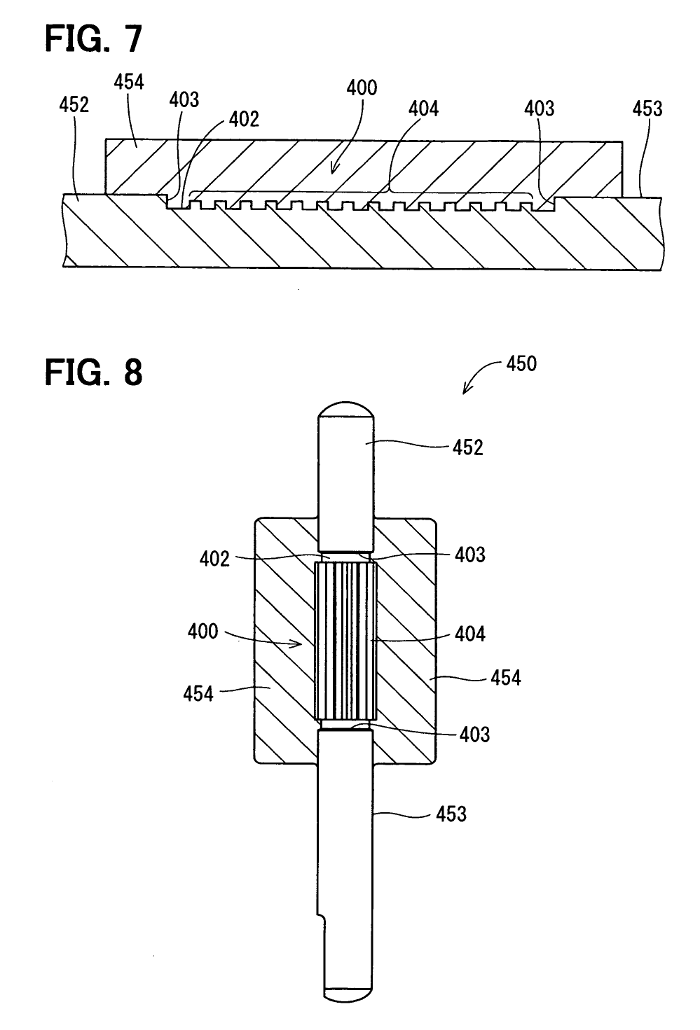

The rotator 450 includes a shaft 452 and a permanent magnet 454. The rotator 450 is rotatable around the inner circumferential periphery of the stator core 430. The shaft 452 is rotatably supported by bearings 426 at both ends. The shaft 452 has an outer circumferential periphery 453 that defines a recess 400. Specifically, as shown in FIG. 7, the recess 400 is defined by steps 403 and a knurl groove 404, for example. The steps 403 are defined by a small diameter portion 402 of the shaft 452. The knurl groove 404 is defined on the outer circumferential periphery of the small diameter portion 402.

The permanent magnet 454 is a cylindrical resin magnet that covers the recess 400 of the shaft 452. The permanent magnet 454 serves as a resin portion. The permanent magnet 454 is formed by injection molding a composite material produced by mixing magnetic powder with thermoplastic resin such as polyphenylene sulfide (PPS) and poly acetal (POM). The permanent magnet 454 has eight magnetic poles 455 arranged with respect to the rotative direction. The eight magnetic poles 455 are magnetized to define magnetic poles toward the outer circumferential periphery of the permanent magnet 454. The outer circumferential periphery of the permanent magnet 454 is opposed to the inner circumferential periphery of the stator core 430. The magnetic poles are different from each other with respect to the rotative direction of the rotator 450.

The end cover 448 is integrally molded of an electrically insulative resin material 446 that covers each of the coils 442 and the end of the stator core 430 on the opposite side of the pump portion 412 with respect to the stator core 430. The end cover 448 has an outer circumferential periphery 449 to which an end 415 of the housing 414 is press-fitted.

The end cover 448 has the outlet port 474 that accommodates a valve member 460, a stopper 462, and a spring 464. The valve member 460 is lifted against bias force of the spring 464 when pressure of fuel pressurized in the pump portion 412 becomes equal to or greater than a predetermined pressure, so that fuel is discharged toward the engine through the outlet port 474.

As referred to FIG. 7, in the fourth embodiment, the shaft 452 has the recess 400, and the permanent magnet 454 covers the recess 400. The contact area between the shaft 452 and the permanent magnet 454 is enlarged by defining the steps 403 and the knurl groove 404, so that bond strength between the shaft 452 and the permanent magnet 454 can be enhanced.

Furthermore, the permanent magnet 454 is directly formed on the outer circumferential periphery 453 of the shaft 452 by injection molding, so that the recess 400 of the shaft 452 is copied on the surface of the permanent magnet 454 on the side of the shaft 452. Consequently, the permanent magnet 454 engages with the recess 400 of the shaft 452. Thus, even when the permanent magnet 454 is peeled from the shaft 452, the permanent magnet 454 does not move relative to the shaft 452. Specifically, the permanent magnet 454 engages with the steps 403, so that the permanent magnet 454 can be restricted from moving with respect to the axial direction of the shaft 452. The permanent magnet 454 engages with the knurl groove 404, so that the permanent magnet 454 can be restricted from rotating relative to the shaft 452.

The knurl groove 404 may be a diamond knurl depicted in FIG. 6 as an example. The diamond knurl has a pattern in a substantially twilled-shape. For example, substantially diamond shaped patterns are substantially regularly arranged to form a hatched texture in the diamond knurl. The knurl groove 404 may be a straight knurl depicted in FIG. 8. For example, the substantially straight grooves, which axially extend along the outer circumferential periphery of the small diameter portion 402, are circumferentially arranged at regular intervals to form the straight knurl. The knurl groove 404 may be a knurl, which is slanted.

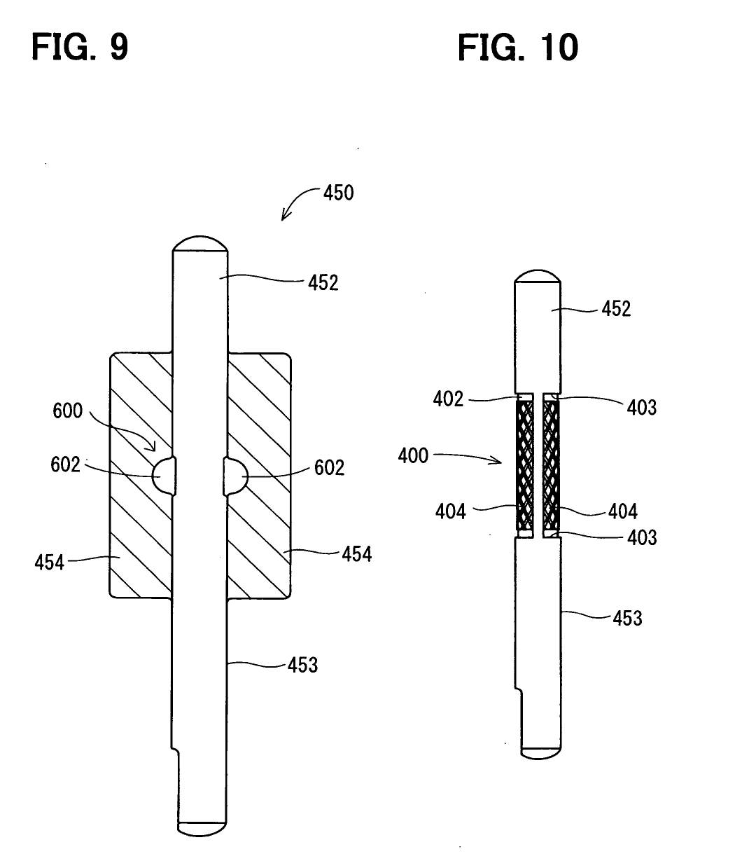

As shown in FIG. 9, the rotator 450 may be constructed of the shaft 452, which has a protrusion 600, and a permanent magnet 454, which covers the protrusion 600. For example, protruding portions 602 may be formed as the protrusion 600. The protruding portions 602 protrude with respect to the radial direction of the shaft 452. In this structure, the permanent magnet 454 engages with the protruding portions 602, so that the permanent magnet 454 can be restricted from rotating relative to the shaft 452, and the permanent magnet 454 can be restricted from moving in the axial direction of the shaft 452.

The knurl groove 404 may be defined on the outer circumferential periphery of the protrusion 600.

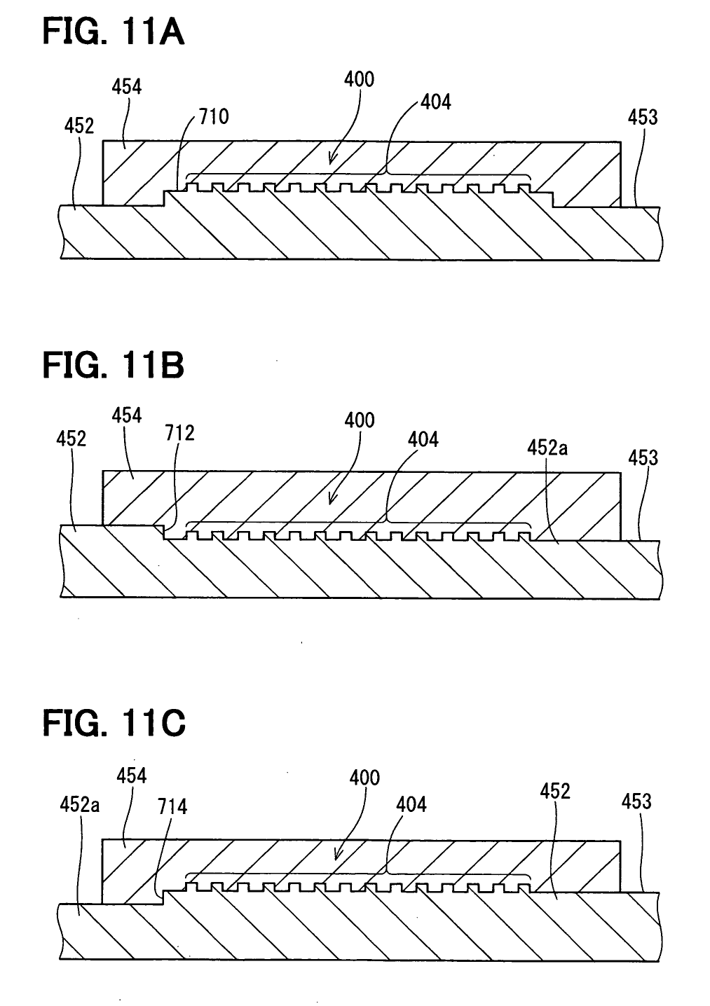

As shown in FIG. 11A, the shaft 452 may have a protrusion 710, which radially protrude from the outer circumferential periphery 453 of the shaft 452. The knurl groove 404 may be defined on the protrusion 710.

The recess 400 or the protrusion 600, 710 need not be formed entirely in the outer circumferential periphery 453 of the shaft 452. As shown in FIG. 10, for example, the recess 400 or the protrusion 600, 710 may be formed partially in the outer circumferential periphery 453 of the shaft 452.

Furthermore, as shown in FIGS. 11B, 11C, the recess 400 may have a step 712 or a step 714 defined on one side of the knurl groove 404 with respect to the axial direction of the shaft 452.

### Fifth Embodiment

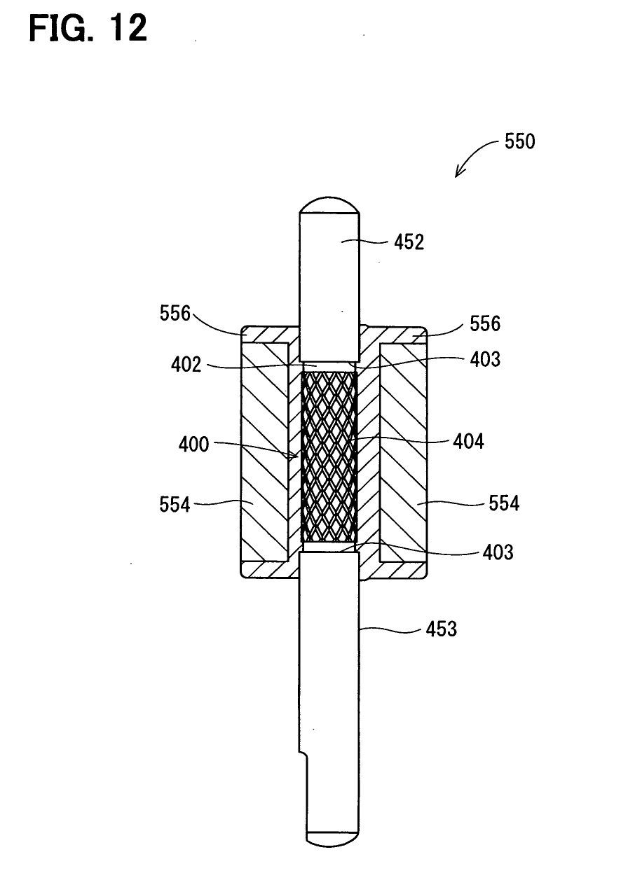

As shown in FIG. 12, a rotator 550 of the motor portion according to the fifth embodiment includes the shaft 452, a mounting member 556, and a permanent magnet 554. The mounting member 556 covers the recess 400 of the shaft 452. The mounting member 556 serves as a resin portion. The mounting member 556 is formed by injection molding a composite material produced by mixing magnetic powder with thermoplastic resin such as PPS and POM. The mounting member 556 is provided to the permanent magnet 554. The permanent magnet 554 is magnetized to define magnetic poles similarly to those of the permanent magnet 454 according to the fourth embodiment.

In the fifth embodiment, the mounting member 556 covers the recess 400 of the shaft 452. In this structure, the contact area between the shaft 452 and the mounting member 556 is enlarged by defining the steps 403 and the knurl groove 404. Therefore, bond strength between the shaft 452 and the mounting member 556, to which the permanent magnet 554 is provided, can be enhanced.

Furthermore, the mounting member 556 is directly formed on the outer circumferential periphery 453 of the shaft 452 by injection molding, so that the recess 400 of the shaft 452 is copied on the surface of the mounting member 556 on the side of the shaft 452. Consequently, the mounting member 556 engages with the recess 400 of the shaft 452. Thus, even when the mounting member 556 is peeled from the shaft 452, the permanent magnet 554 and the mounting member 556 do not rotate relative to the shaft 452, and the permanent magnet 554 and the mounting member 556 do not move with respect to the axial direction of the shaft 452.

### Sixth Embodiment

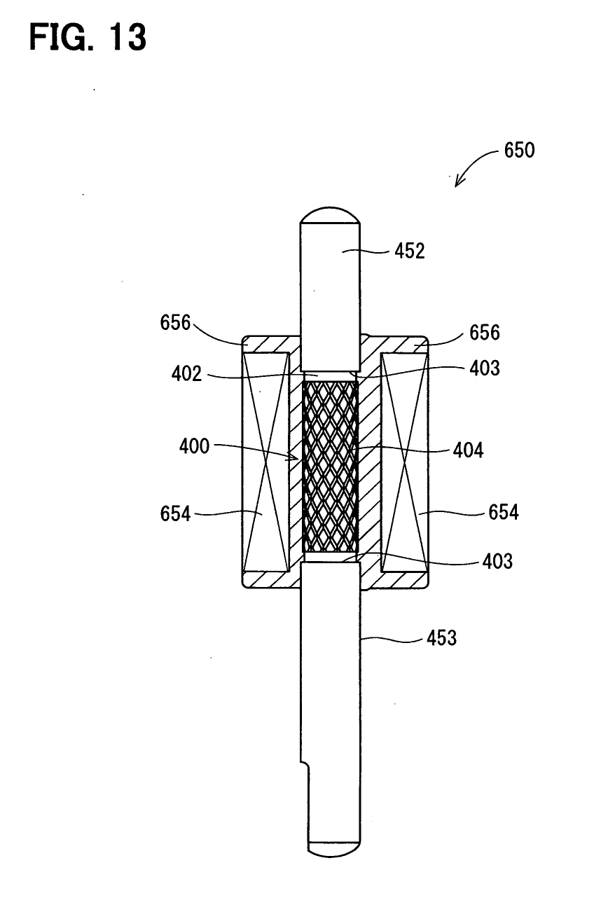

As shown in FIG. 13, the motor portion includes a rotator 650 that is constructed of a mounting member 656 and a coil 654. The mounting member 656 serving as a resin portion is injection molded on the shaft 452, similarly to the mounting member 556 of the fifth embodiment. The mounting member 656 is provided with multiple coils 654 arranged with respect to the rotative direction of the rotator 650. The coils 654 are in delta connection. The coils 654 adjacent to each other with respect to the rotative direction are wound in the direction opposite to each other.

Therefore, bond strength between the shaft 452 and the mounting member 656, to which the coils 654 are provided, can be enhanced. Furthermore, the coils 654 and the mounting member 656 can be restricted from rotating relative to the shaft 452, and the coils 654 and the mounting member 656 can be restricted from moving with respect to the axial direction of the shaft 452.

In the above embodiments, when the recess is defined circumferentially throughout the outer circumferential periphery of the shaft, bond strength between the resin portion and the shaft can be further enhanced. That is, a problem caused by debonding the permanent magnet or the coil from the shaft can be further steadily restricted.

In the above embodiments, a knurl groove of a general knurl such as a diamond knurl, a straight knurl, and a slanted knurl may be inclined by a predetermined angle with respect to the circumferential direction of the shaft. In this structure, the resin portion can be steadily restricted from rotating relative to the shaft. Furthermore, when the shaft has the step, the resin portion engages with the step, so that the resin portion can be restricted from moving with respect to the axial direction of the shaft. That is, the permanent magnet or the coil can be restricted from rotating relative to the shaft and moving with respect to the axial direction of the shaft.

In the above embodiments, when the recess is defined entirely in the outer circumferential periphery of the shaft, bond strength between the resin portion and the shaft can be further enhanced, so that a problem caused by debonding the permanent magnet or the coil from the shaft can be steadily restricted.

### Other Embodiment

In the second and third embodiments, one, two or more of the injection port mark 266 of the permanent magnet 264 and the injection port mark 366 of the permanent magnet 332 may be formed, similarly to the injection port mark 66 of the permanent magnet 64 in the first embodiment.

The above structures and manufacturing method can be applied to various kinds of fluid pumps and electric motors. The fluid pump is not limited to be applied to a gasoline engine as a fuel pump, and may be applied to a diesel engine or an engine using alcohol fuel.

The recess 400 and the protrusion 600 of the shaft 452 are not limited to the shapes shown as examples. The recess 400 and the protrusion 600 may be in various shapes as long as the permanent magnet 454, the permanent magnet 554, or the coil 654 can be restricted from being peeled off the shaft 452, and the permanent magnet 454, the permanent magnet 554, or the coil 654 can be restricted from moving relative to the shaft 452.

Furthermore, in the fifth embodiment, the mounting member 556 and the permanent magnet 554 may be formed on the outer circumferential periphery 453 of the shaft 452 by injection molding in two stages. In this structure, the permanent magnet 554 may be restricted from being peeled off the mounting member 556 by defining a recess and a protrusion in the mounting member 556 similarly to the recess 400 and the protrusion 600 of the shaft 452 thereby enhancing the bond strength between the mounting member 556 and the permanent magnet 554.

The above structures of the embodiments can be combined as appropriate.

Various modifications and alternations may be diversely made to the above embodiments without departing from the spirit of the present invention.

What is claimed is:

1. A fluid pump comprising:
a motor portion that includes a stationary part and a rotator, the stationary part having an inner circumferential periphery, the rotator having an outer circumferential periphery, the inner circumferential periphery and the outer circumferential periphery defining a fuel passage therebetween, the rotator is rotatable around the inner circumferential periphery; and
a pump portion that is driven by the motor portion for pumping fuel through the fuel passage,
wherein the rotator includes a permanent magnet that is formed by injection molding a composite material containing a magnetic material and resin,
the permanent magnet has one end with respect to an axial direction of the permanent magnet, the one end defining an axial end surface, and
the axial end surface has an injection port mark.

2. The fluid pump according to claim 1, wherein the injection port mark is spaced from an outer circumferential end of the rotator for a predetermined distance in the axial end surface.

3. The fluid pump according to claim 2, wherein the predetermined distance is equal to or greater than 0.3 mm.

4. The fluid pump according to claim 1, wherein the resin is polyphenylene sulfide.

5. A fluid pump comprising:
a motor portion that includes a stationary part and a rotator, the stationary part having an inner circumferential periphery, the rotator having an outer circumferential periphery, the inner circumferential periphery and the outer circumferential periphery defining a fuel passage therebetween, the rotator being rotatable around the inner circumferential periphery; and
a pump portion that is driven by the motor portion for pumping fuel through the fuel passage,
wherein the stationary part includes a permanent magnet that is formed by injection molding a composite material containing a magnetic material and resin,
the permanent magnet has one end with respect to an axial direction of the permanent magnet, the one end defining an axial end surface, and
the axial end surface has an injection port mark.

6. The fluid pump according to claim 5, wherein the injection port mark is spaced from an inner circumferential end of the stationary part for a predetermined distance in the axial end surface.

7. The fluid pump according to claim 6, wherein the predetermined distance is equal to or greater than 0.3 mm.

8. The fluid pump according to claim 5, wherein the resin is polyphenylene sulfide.

9. A manufacturing method for a fluid pump, the fluid pump including:
a motor portion that includes a stationary part and a rotator, an inner circumferential periphery of the stationary part and an outer circumferential periphery of the rotator defining a fuel passage therebetween, the rotator being rotatable around the inner circumferential periphery, one of the stationary part and the rotator including a permanent magnet having an axial end surface on a side of one end of the permanent magnet with respect to an axial direction of the permanent magnet; and
a pump portion that pumps fuel through the fuel passage by being driven by the motor portion,
the manufacturing method comprising:
forming the permanent magnet by injection molding a composite material containing a magnetic material and resin using a die having an injection port in a portion for forming the axial end surface of the permanent magnet.

10. A manufacturing method for a permanent magnet constructing one of a stationary part and a rotator of an electric motor, the manufacturing method comprising:
injecting a composite material containing a magnetic material and resin into a die through an injection port;
forming a permanent magnet, which is in a substantially cylindrical shape, in the die by solidifying the composite material in the die and the injection port; and
removing the composite material, which is solidified in the injection port, from an axial end surface of the permanent magnet, the axial end surface defining one end of the permanent magnet with respect to an axial direction of the permanent magnet.

11. A manufacturing method for an electric motor including a permanent magnet constructing one of a stationary part and a rotator, the manufacturing method comprising:
injecting a composite material containing a magnetic material and resin into a die through an injection port;
forming a permanent magnet, which is in a substantially cylindrical shape, in the die by solidifying the composite material in the die and the injection port;
removing the composite material, which is solidified in the injection port, from an axial end surface of the permanent magnet, the axial end surface defining one end of the permanent magnet with respect to an axial direction of the permanent magnet; and
combining the permanent magnet as the one of the stationary part and the rotator substantially coaxially with an other of the stationary part and the rotator such that the permanent magnet and the other of the stationary part and the rotator define a substantially cylindrical fluid passage radially therebetween.

12. An electric motor comprising:
a stationary part that has an inner circumferential periphery; and
a rotator that is rotatable around the inner circumferential periphery,
wherein the rotator includes a shaft and a resin portion,
the shaft has an outer circumferential periphery that defines a recess,
the resin portion is formed by injection molding one of resin and a composite material, the composite material containing resin, and
the resin portion covers the recess.

13. The electric motor according to claim 12, wherein the recess is defined circumferentially throughout the outer circumferential periphery.

14. The electric motor according to claim 12,
wherein the shaft has a small diameter portion, and
the recess has a step and a knurl groove, the small diameter portion defines the step, and the small diameter portion has an outer circumferential periphery defining the knurl groove.

15. The electric motor according to claim 14, wherein the knurl groove is in a substantially twilled shape.

16. The electric motor according to claim 12, wherein the resin portion is a permanent magnet that is formed of a composite material containing resin and a magnetic material.

17. The electric motor according to claim 12, wherein the rotator includes a permanent magnet that is provided to the resin portion.

18. The electric motor according to claim 12,
wherein the resin portion of the rotator includes a plurality of coils that defines a plurality of magnetic poles by being supplied with electricity, and
the plurality of magnetic poles is switched with respect to a rotative direction of the rotator by controlling the electricity supply.

19. An electric motor comprising:
a stationary part that has an inner circumferential periphery; and
a rotator that is rotatable around the inner circumferential periphery,
wherein the rotator includes a shaft and a resin portion,
the shaft has an outer circumferential periphery that defines a protrusion,
the resin portion is formed by injection molding one of resin and a composite material, the composite material containing resin, and
the resin portion covers the protrusion.

20. The electric motor according to claim 19, wherein the protrusion is defined circumferentially throughout the outer circumferential periphery.

21. The electric motor according to claim 19, wherein the protrusion includes a protruding portion that protrudes with respect to a radial direction of the shaft.

22. The electric motor according to claim 19, wherein the resin portion is a permanent magnet that is formed of a composite material containing resin and a magnetic material.

23. The electric motor according to claim 19, wherein the rotator includes a permanent magnet that is provided to the resin portion.

24. The electric motor according to claim 19,
wherein the resin portion of the rotator includes a plurality of coils that defines a plurality of magnetic poles by being supplied with electricity, and
the plurality of magnetic poles is switched with respect to a rotative direction of the rotator by controlling the electricity supply.
